(19) United States
(12) Patent Application Publication
(10) Pub. No.: US 2006/0004907 A1
(43) Pub. Date: Jan. 5, 2006

(54) Method and system for private data networks for sharing agricultural item attribute and event data across multiple enterprises and multiple stages of production transformation

(76) Inventors: William R. Pape, Los Ojos, NM (US); Aj Dolan, Arvada, CO (US); Lee Curkendall, Westminster, CO (US); Robert D. Boyle, Mableton, GA (US)

Correspondence Address: Rick B. Yeager, 10805 Mellow Lane, Austin, TX, 78759, US

(21) Appl. No.: 11/112,419

(22) Filed: Apr. 22, 2005

Related U.S. Application Data
(60) Provisional application No. 60/564,646, filed on Apr. 22, 2004.

(51) Int. Cl. G06F 15/16

(52) U.S. Cl. 709/201

(57) ABSTRACT

A system of private data networks for sharing agricultural item information across production segments. Each network has shared communication between enterprise applications and one or more transactional event database for acquiring and storing event data for measurements, inputs, processing, transfers, and transformations of uniquely identified units of production. The data is stored at an atomic level with event data elements including an enterprise identifier, a unit of production identifier, a unit of production type description, an event type, and an event detail. The event data elements permit a tracking of the units of production through changes in ownership, changes in location, conversion of quantities of units of production, and changes in physical form. Additional event data elements may be provided for data security and auditing. Data marts are used to consolidate data related to particular business decisions.

### RELATED APPLICATIONS

This application is related to U.S. Provisional Patent Application No. 60/564,646 filed Apr. 22, 2004 and claims the benefit of that Provisional Patent Application.

### FIELD OF INVENTION

This application relates to building and using a loosely linked series of private data networks for collecting, processing, sharing, analyzing, and reporting on agricultural item, food ingredient, and food product attribute and event data for appropriately-sized discrete units of production across enterprises in different segments of production.

### BACKGROUND

Prior art systems in agriculture typically comprise separate enterprise applications to support each segment of production. Attempts to link those separate applications typically involve integration through data communications. There is a need for an approach to provide data collection and sharing through a data structure approach in order to enable the sharing of agricultural items and food attributes and event data across multiple enterprises and multiple states of production transformation.

### SUMMARY

An agricultural item such as a grain product is typically owned or processed by a number of different enterprises in multiple locations, and the item typically has several different units of production at these enterprises. Some examples of units of production are bags or lots of a seed; a planted field; containers of a harvested grain, fiber, fruit, or vegetable; and processed intermediate or final products such as flour, dough, or a baked item. The current invention provides a method of tracking individually identified, discrete units of production across these enterprises and forms of production in order to provide access to useful attribute and process data.

In one example of the invention, a commodity product, wheat, is tracked across various units of production so that processing or quality characteristics of a baked product can be correlated with inherent attributes such as the variety of wheat, and to specific processing history such as grinding parameters.

A private data network is built using one or more transactional event databases which facilitate extracting data from multiple enterprise applications to permit capturing, processing, sharing, and reporting on data on appropriately-sized individual units of production in agricultural items including grains and oilseeds, fibers, and fruits and vegetables. Each private data network can cross multiple stages of production, and each enterprise at a stage of production can give data to the private data network or receive data from the private data network.

In one embodiment, the transactional event database includes rows where each row comprises data elements for the enterprise, the type of unit of production and specific unit of production identifiers, the events, and the event values. The database may also include global unique event identifiers, parent event identification, or unit of measure designation. Additional data services such as normalization, security, and auditing, can be provided and supported by additional data elements. The private data network can be implemented incrementally by starting at a single enterprise, and can be expanded to include enterprises upstream and/or downstream from the initial point of implementation. The private data network can incorporate new data collection, and can capture and share data on appropriately-sized individual units of production.

The current invention can be applied across all or any portion of an agricultural item production flow such as between different facilities within an enterprise, between different enterprises, and between an enterprise and a third party such as a service provider or regulatory authority. There is a need to establish a private data network for sharing information between enterprise applications that reside within a given company, between enterprise applications of different companies in the same supply chain, and between enterprise applications and other authorized parties such as governmental agencies. Attribute and event data provide the opportunity for detailed analyses such as actual costs, and correlation analysis to determine the impact of specific attributes on enterprise operations.

The current invention extracts data from existing applications such as relational tables and represents that data at an atomic level in one or more transactional event database (“TEDB”). Information from each enterprise application database such as a relational data table is broken down to a common data format at an atomic level by creating a data base entry, such as a row, in a TEDB for each cell in the relational table. Other data is collected and added to one or more transactional event database. The data may be restructured to data marts that are designed to serve one or more specific business problems. It is not necessary to define these business problems in advance of collecting and sharing the data, so a private data network system can be developed incrementally and in a non-disruptive manner.

The atomic level of representation permits the current invention to determine and to share information about an agricultural item unit of production with precision. The event level atomic data representation for individual units of production represents a deliberate deconstruction of group data and multiple event data so that the most precise information about the unit of production can be reassembled in a useful manner. For instance, in a relational database, a row may represent either a particular unit of production of an agricultural item, or a collection of several units of production. The columns in the relational database may represent multiple events, and the cells may represent event values. In the current invention, each row of data in such a relational database is atomized by representing each cell value as a row in a transactional event database. Additional rows may be created for each cell in those situations where the relational database row represents a collection of agricultural items. If the components of a collection are known, then the current invention may create a separate row for each component such that each of those duplicate rows may have the same event and event detail, but unique unit of production identifiers for each component of the collection.

One advantage to this type of representation is in the amount of data to be shared between applications. For example, if a row in a relational data base includes information for 80 attributes, but only 20 attributes are of interest for a particular data mart, only those attributes of interest need be shared. Thus the current invention permits sharing of the most discrete data attributes as possible.

Another advantage of the event representation is that only those attributes that are intended to be shared are made available to other enterprises, and the remaining information in the relational database is not shared with other enterprises. It is not necessary, for instance, to transfer all of the information from the relational database to other enterprises. Additional security and controls for sharing information are typically provided by the private data network.

A further advantage of the representation is that each row of the transactional event database has enough information to be meaningful, so that other information is not required in order to interpret the row. By contrast, in a relational database, it is typically necessary to know the column names and the table names as well as the row name and the cell value in order to interpret the cell value. In other data representations, a reference table may be required to interpret the data. In a transactional event database, the elements may have human recognizable names or values which assist in updating the information, in understanding an event, or in constructing data marts.

The private data networks and data marts can provide information to differentiate agricultural items on the basis of desirable traits that might otherwise be unknown, and thereby permit commodity items to be converted to items having a higher value.

The current invention provides the unexpected result of being efficient in constructing information systems and in permitting the tracking of appropriately-sized discrete units of production of agricultural items across multiple enterprises in different segments of production. The approach permits a single interface to be established to existing enterprise applications, and facilitates a practical and incremental approach to the collection and sharing of data.

### DESCRIPTION OF FIGURES

FIG. 1 is a representation enterprises in an agricultural item production flow

FIG. 2 is a representation of an enterprise and a process in an agricultural item production flow.

FIG. 3 is a representation of collections of agricultural items in an enterprise.

FIG. 4 represents extracting and sharing data between an existing enterprise applications and a transactional event database.

FIG. 5 represents collecting data from an enterprise process and storing the data in a transactional event database.

FIG. 6 is a representation of the multiple rows of the transactional event database shown in FIGS. 4 and 5.

FIG. 7 is a representation of the data structure rows of the transactional event database for the example shown in FIG. 6

FIG. 8 represents a method of collecting and accessing attribute data in a private data network.

FIG. 9 is a representation of a transactional event database with additional data elements.

FIG. 10 represents the extraction of data from a data table to a transactional event database and to data marts.

FIG. 11A is a representation of a first stage of building a private data network

FIG. 11B is a representation of a second stage of building a private data network

FIG. 12A is a high level production flow diagram for a wheat example

FIG. 12B is a detailed production flow diagram for the wheat example of FIG. 12A.

FIG. 12C is a continuation of the detailed production flow diagram of FIG. 12B.

FIG. 13 is a table which illustrates the data structure for tracking the wheat through a production flow.

FIG. 14 is a table illustrating a data mart for the wheat example of FIGS. 12B and 13.

### DETAILED DESCRIPTION OF EMBODIMENT

### Private Data Network for Collecting, Processing, Sharing, Analyzing, and Reporting on Agricultural Item, Food Ingredient, and Food Product Attribute and Event Data for Appropriately-Sized Discrete Units of Production Across Multiple Enterprises

This embodiment is a description of the components of a private data network (PDN), where the network is used to collect attribute data within and across multiple enterprises associated with the production and distribution flow of an agricultural item. In similar examples, one or more private data network can be used within a given enterprise or segment of production, such as across multiple mills for a mill flour company.

The data from a PDN may then be used by the various enterprises to improve intra-enterprise operational processes, intra-enterprise operational efficiency, product specifications/new product development, and regulatory compliance.

The PDN data may also be used to improve inter-enterprise operational efficiency, such as assistance in selecting the appropriate wheat varieties and growing events that will minimize wastage; minimizing the resetting of oven temperature at baking; or maximizing the batch yield based upon characteristics of incoming lots (units of production).

The following is a discussion of components of the agricultural item production flow and the private data networks. In this embodiment, a private data network includes at least one transactional event database (TEBD) which is typically used for extracting data from existing enterprise applications, and for collecting and storing new data. This system and method has several advantages, including the ability to incrementally build the private data networks in cooperation with existing enterprise applications; and to easily expand the networks to facilitate discovering and utilizing new relationships between data attributes formed at one enterprise and the effects of those attributes on downstream entity quality and operational efficiency.

Agricultural Item

In this embodiment, an agricultural item may be a plant product such as grain, oilseed, fruit, vegetable, fiber such as cotton or wood products. The agricultural item typically is processed through a number of enterprises as described below.

Attribute Data

In this embodiment, the term “characteristics” will refer to all properties of a type of agricultural item, and the term “data attributes” or “attribute data” will refer to those characteristics which are measured or which will be measured. Attribute data includes data related to events such as measurement events, inputs, processing conditions, agricultural item transfers of ownership, and unit of production transformations. Examples of measurement events include weight measurement, composition analysis, and determination of other agricultural item characteristics. Examples of inputs include details related supplements, fertilizers, pesticides, and herbicides. Examples of processing conditions include process type, process parameters, and time of processing. Examples of transfer of ownership include the physical movement of an agricultural item from one location to another, and the transfer of title for an agricultural item without movement of the item. Examples of unit of production transformations or conversions include both changes in quantity and changes in physical or chemical characteristics such as the division of a unit of production into two or more separate units of productions, combination of two or more unit of production to a new unit of production and blending.

As systems related to the current invention are deployed, the set of data attributes is expected to increase in order to support the operations and decision-making of various enterprises.

There is typically substantial variability in the characteristics of an agricultural item. For example, an agricultural item such as corn can have a range of composition of protein and carbohydrate content. A first corn sample with a relatively high concentration of a particular amino acid may be more effective in the weight gain of fed livestock than a second corn sample with a lower composition of that particular amino acid. At the same time, the second corn sample may have a more favorable composition of carbohydrates that would be more useful in ethanol production than the first sample. A purchaser of corn for a particular application such as livestock feed or ethanol production, would preferably know the protein and carbohydrate composition of the corn in order to make a decision whether to purchase the corn and what to pay for the corn.

At this time, many aspects of agricultural item processing are more closely related to a pure commodity market, such as treating all corn the same in purchase and operation, than an informed market where those purchase and operating decisions are based upon actual data attributes. One benefit of the current invention is to provide useful and specific information that can differentiate particular units of production of agricultural items that were previously considered to be the same commodity. This de-commoditization of agricultural items and food products benefits both the producer or processor and the downstream enterprises.

The Process of Quality Improvement

An aspect of the variability of agricultural items relative to subsequent processing or use of the items is that many important relationships such as the corn amino acid example may either have not yet been discovered; or if the relationships have been discovered, they may not be widely understood. A related aspect of this lack of understanding is that many data attributes of an agricultural item have not been routinely measured. To complicate this lack of understanding, the natural variability of agricultural items tends to be greater than materials used in other industries.

Historically, many producer level enterprises have production practices guided by heuristics and conventional wisdom that may not be accurate. By measuring data attributes, these enterprises can be provided with accurate information about the consequences of their processing decisions, such as which variety of wheat will produce a better quality of a food product, or whether wheat grown under certain weather conditions provides better characteristics for a given use of the wheat.

The agricultural industry can benefit from the continual quality improvement that can be obtained by closer measurement of quality attributes and informed decision-making based on those measurements. In many cases, new relationships between the data attributes will be discovered from the data collection and subsequent correlation and analysis. For instance, independent variables such as ingredient attributes and production events have effects on dependent variables such as the amount, cost, and quality of the food products produced. As this measurement and informed decision-making is more widely adopted, the nature of the agricultural industries is likely to shift away from pure commodity-based strategies.

The current invention supports strategies of both experimentation and observation. In agriculture, some relationships can be discovered by deliberate experimentation and control of the variables. In general, however, it is desirable to learn as much as practical without disrupting existing production. The current invention enables the gathering and analysis of large amounts of information so that important relationships can be discovered without impacting production. The availability of this information supports a continual improvement of the production processes by identifying and controlling sources of variation.

In an ideal world, an enterprise would have identified desired agricultural item characteristics so that it could (a) establish appropriate product specifications for agricultural items; (b) pay for agricultural items according to the value of particular lots of the item rather than treat all lots as the same commodity; (c) adjust, as frequently as necessary, its processing conditions based on actual agricultural item characteristics; and (d) source the exact agricultural products it needed when it needed them and reduce or eliminate non-value added stage of production, such as the excess co-mingling and blending of products, excess transportation of products, and carrying of excessive raw materials inventories at production locations.

Similarly, in that ideal world, an agricultural producer or upstream entity would know the agricultural item characteristics of items that it was producing, or could produce, so that it could determine the best purchaser, or best price, for its agricultural items; and make informed input and processing decisions for its operations.

Constraints

In such an ideal world, the various parties in an agricultural item production flow might agree to work together to design and to build information systems to support such goals and procedures. The world of agricultural item processing, however, is non-ideal in many respects, and the current invention provides a number of novel and practical solutions to this non-ideal situation.

Many agricultural enterprises tend to be disjoint, and may include substantial separation by geography, time of processing activity, ownership, and interests.

Although many agricultural enterprises have reasonably sophisticated information system applications, those applications are typically legacy systems or locally optimized systems such that the enterprises in a production flow are typically not linked to permit effective sharing of agricultural item data attribute information. An information system within a given company may not be linked across similar facilities. For instance, multiple flour mills within the same company might not have integrated information systems. These differences make it difficult, if not impossible, to perform benchmarking and analyses across facilities within the same company. A private data network system may begin within a given facility, and then expand to integrate systems across facilities within the same company, and finally move outside of the company to other enterprises such as vendors, suppliers, and customers.

As the agricultural items are processed to various end products, the items may undergo multiple changes in ownership and conversions of units of production, including both changes in quantity and changes in form.

The motivation to develop improved data attribute measurement, tracking, and sharing may differ from one enterprise to another, so such development is more likely to be incremental than a system-wide redesign. In an incremental approach, a solution must provide value to one enterprise without disrupting other enterprises. This incremental approach is often more practical than attempting a more ambitious approach to integration.

Even if there was a willingness of all enterprises to work together to develop a single system, there are two major obstacles. It is difficult to pre-define a data dictionary, business rules, or other system design elements for an all-inclusive application. In addition, the system is dynamic in that many important relationships cannot be pre-defined, and are more appropriately incorporated in an incremental fashion.

Enterprise

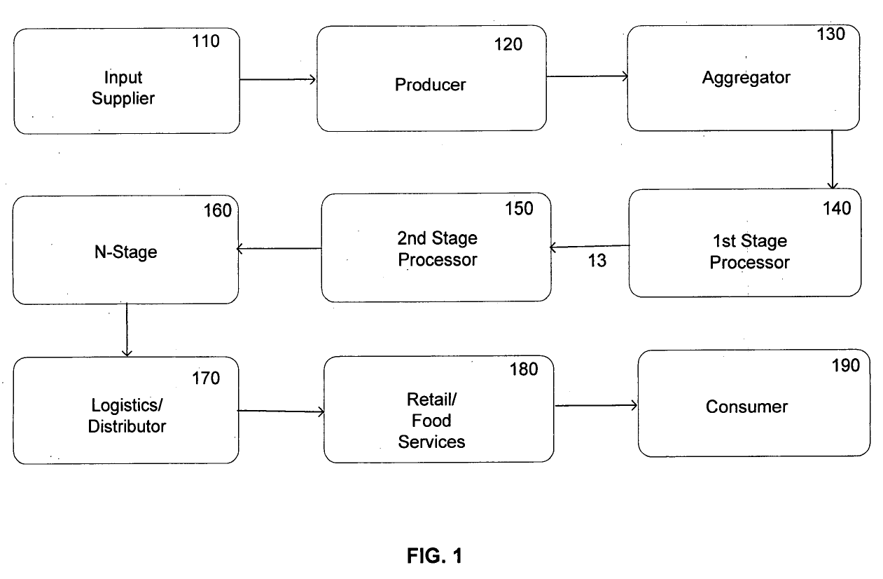

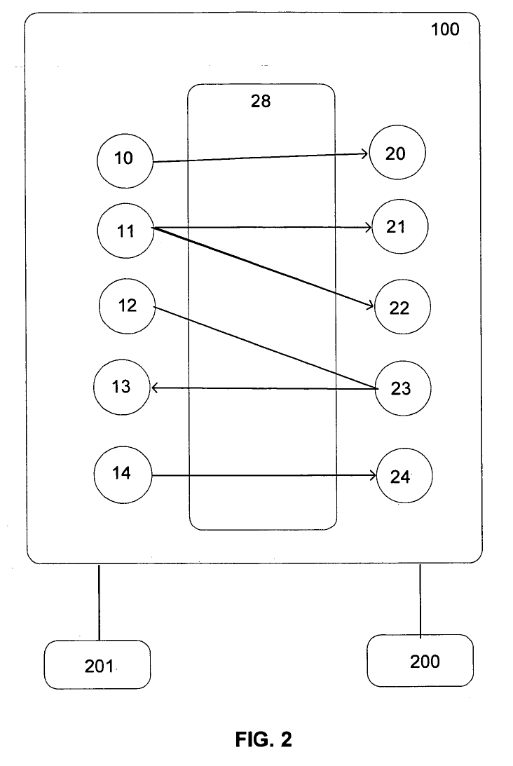

FIG. 1 is a representation of enterprises 110-190 in an agricultural item production flow. An enterprise may be a physical or virtual entity in the production flow of the agricultural item. Enterprises typically include input suppliers 110 such as seed, breeding stock, or fertilizer supply companies; producers 120 such as farmers, growers, and ranchers; aggregators 130 such as cooperative grain storage facilities; first stage processors 140 such as flour mills and packing plants; second stage processors 150 such as bakeries; “N” Stage Processors 160, distributors 170, and retailers or food service providers 180, and consumers 190. In addition to this direct agricultural item flow, other entities such as local, state, and federal government and industry self-regulatory bodies, have. an interest in the production flow, particularly related to enforcing regulations or certifying standards. For various agricultural items and end products, this production flow may be substantially different, with more or fewer enterprises. FIG. 1 is also simplified in that at various points in the production flow, an enterprise may be supplied by two or more upstream enterprises, or the unit of production may be split into two or more separate units.

In this discussion, the production flow is from the input supplier 110 enterprise towards the consumer 190. In this discussion, for a given enterprise such as the first stage processor enterprise 140, the term “upstream” refers to the enterprises 130, 120 and 110 which precede the first stage processor in the production flow, and the term “downstream” refers to the enterprises 150, 160, 170, 180 and 190 which follow the first stage processor in the production flow.

Enterprise Processing Events

FIG. 2 is a representation of a general enterprise 100, which may own or process a plurality of agricultural items. Items 10, 11, 12, 13, and 14 represent uniquely identified units of production within the enterprise. Some examples of units of production are various forms of seed, crop fields, grain containers, or product lots.

In FIG. 2, element 28 represents an enterprise process which may act on the units of production (UOP) in enterprise 100. Several processes may be included in each enterprise. Examples of processing events at an enterprise include chemical, biological, or mechanical inputs; physical or chemical transformations; measurements of the agricultural items; aggregation; and assembly or disassembly. Some of these events produce a change in form of production of the agricultural item, and other events do not change the form of production. The transfer of an unit of production from a first enterprise to a second enterprise typically does not involve a change in the form of the unit of production.

In FIG. 2, elements 10-14 and 20-23 represent UOPs. UOP 14 is unchanged through the process 28 and could represent a weight measurement of a UOP 14 or the transport of UOP 14 from one location to another location. UOPs 12 and 13 are combined to UOP 23 which could represent a simple blending of UOPs 12 and 13, or it may represent a blending and change of physical or chemical properties. For instance, in one example, UOPs 12 and 13 may be two containers of grain that are blended to create UOP 23. In another example, the blended grain may be milled so that UOP represents a flour rather than a grain. UOP 11 is split into UOP 21 and 22. UOP 10 is converted to UOP 20.

The private data network records through one or more transactional event data base, the data attributes associated with these transports, transformations, and measurements of the unit of productions.

Enterprise Application

The enterprise typically uses one or more enterprise applications such as 200 and 201 for functions such as accounting, process control, procurement, inventory management, logistics management, or production management. An enterprise application is typically a computer-based software system that is used in one or more enterprises. The enterprise applications represent systems which support the enterprise business. The enterprise applications may record and store a quantity of data attribute information, although that attribute information is typically not in a convenient form for sharing that information with other enterprises. One aspect of the current invention is to provide systems and methods that coordinate, in a non-disruptive manner, the sharing of such information among enterprises. This sharing is accomplished without creating unique interfaces between particular enterprise applications. Typically a single interface is created between an enterprise application and a private data network, and other enterprise applications can access the information from the PDN.

The enterprise applications typically store attribute data and other information in proprietary data files, flat files, or relational data structures. These data structures vary from application to application. One aspect of the current invention is the use of a standardized event data structure to represent data extracted from these enterprise applications. In this example, the same data structure is used for newly collected data.

The enterprise applications 200, 201 typically contain information about some, but not all, agricultural processing events that occur within an enterprise. It is desirable to provide a private data network that utilizes data from the applications, and which accepts new event data which has is not collected by the existing applications. As described below, information can typically be extracted by decomposing data structures associated with enterprises such as applications 200 and 201. Other process event data is collected as necessary.

Collection of Items

As indicated in FIG. 2, the particular processing events may be different from one individual unit of production to another. Agricultural items that share a common processing history at an enterprise are defined in this embodiment as a “collection”.

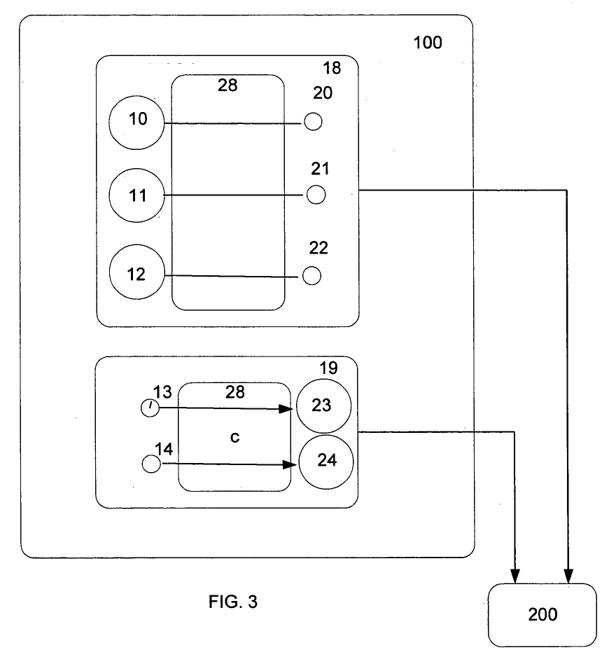

In the example of FIG. 3, an enterprise application 200 contains information about a first collection 18 of agricultural items 10, 11, and 12 which share a common processing history 28 at enterprise 100. Units of production 13 and 14 represent a second collection 19 of agricultural items which share a common processing history 28 at enterprise 100.

Examples of collection of items include a bin of grain, or a tub of vegetables, or the items that were processed at a particular date or time. Agricultural items have been historically consolidated for convenience of handling, processing, or accounting into collection of items; and the data in the enterprise applications may reflect these consolidations. In this example, the enterprise application tracks collections 18 and 19. In conventional enterprise applications, this tracking is typically accomplished as a first grouping to the input unit of productions 10, 11, 12; and a grouping of the output unit of productions 20, 21 and 22. A second grouping may include input of units of productions 13 and 14; and a grouping of the output unit of productions 23 and 24. The data for these input and output unit of productions is typically recorded as a single entry for the group.

One aspect of the-current invention is to record as much discrete attribute data as can be extracted or collected related to the unique unit of productions 10,11, 12 13, 14, 20, 21, 22, 23, and 24 so that the attribute data may be available for subsequent analysis and decision support. The enterprise application may track a collection such as 18 rather than individual units of production within the collection, such as agricultural items 10 and 11. Unfortunately, one consequence of recording data for a collection is that the consolidation may conceal more specific information about the individual UOPs that comprise the collection. For instance, if an enterprise groups the individual UOPs and records data on the group 18, then information about the UOPs which comprise the group may be lost. An aspect of the current invention is the conversion of such enterprise group information to determine and store attribute data for the discrete units of production 10 and 11. In this example, a discrete unit of production is a defined volume, weight, or quantity of an item regardless of its state.

Transactional Event Database (TEDB)

In this embodiment, the determination of attribute data for a UOP of an agricultural item from a group or collection is accomplished through a system including one or more transaction event databases. A transaction event database typically comprises a plurality of entries, where each entry stores information related to an event. In this embodiment, the events are typically agricultural item processing events. In one embodiment, the entries are rows. The event data may be determined from extracting information from existing enterprise application, from the collection of new data, or from the sharing of data from another enterprise or another TEDB.

Extracting Information from an Enterprise Application

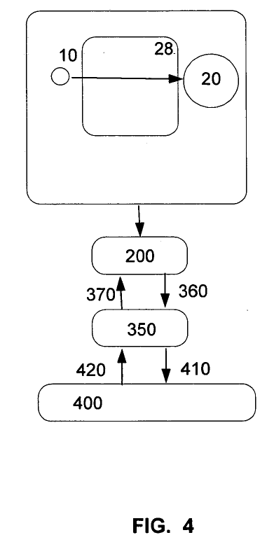

In FIG. 4, data is extracted from enterprise application 200 to a TEDB 400, or supplied to the enterprise application 200 from the TEDB 400, through shared communication 350. The communication includes a first transactional event data base portion with on-ramp 410 from the shared communication 350 to the TEDB 400 and an off-ramp 420 from the TEDB 400 to the shared communication 350. The communication also includes a second enterprise application portion with an on-ramp 370 from the shared communication 350 to the enterprise application 200 and an off-ramp 360 from the enterprise application 200 to the shared communication 350.

If common event data structures are used in multiple TEDBs in a private data network, this on-ramp 410 and off-ramp 420 will typically be common to the TEDBs. The second portion of the communication with on-ramp 370 and off-ramp 360 is typically created for each different enterprise application. However, once the on-ramp 370 and off-ramp 360 have been created, they can be used for similar applications in other enterprises. For instance, once the interface is made to an accounting system for one enterprise, that interface can be re-used for that same accounting system in other enterprises.

By creating a single interface with on-ramp 370 and off-ramp 360 between an enterprise application and the shared communication, all data in the private data network can be shared with other enterprises which are part of the network. Thus by creating a single interface from an enterprise to the shared communication, data from the enterprise application can be shared to and from all other applications in the private data network. This approach is much more efficient and practical than creating unique application-to-application interfaces. When an enterprise application is added to the private data network, it is only necessary to create that single interface; and if an interface has already been created for a similar application, then that previous interface can be used.

In its simplest form, an interface-establishes communication between the application and relational database such as provided by standard application program interfaces, secure socket layers, and data exchange protocols. In more advanced forms, the interface may provide data checking, data benchmarking, data normalization, data translation, data routing, audit capabilities, and authorization and security functions such as provided by AgInfoLink Holdings, Inc.'s Food Information Highway™.

Referring again to FIG. 3, a portion of the data in enterprise application 200 relates to a group 18 which includes agricultural item UOPs 10, 11, and 12. Each UOP is processed through process 28 under similar conditions. Information about process 28 and UOPs 10, 11, and 12 is typically stored in enterprise application 200 as a single entry for group 18. When group 18 data is extracted from the enterprise application 200 to the transactional event database 400, it is stored as at least one separate row of a processing event for each UOP, so that there is at least one row for agricultural item 10 undergoing processing event 28, at least one row for agricultural item 11 undergoing processing event 28, and at least one row for agricultural item 12 undergoing processing event 28. In some case there may be more than one event for a processing event. For example, an event may be a parent event and child events can provide additional detail as described in the wheat example below.

The reasons for making this expansion of the data into multiple events are non-intuitive. One reason is that it facilitates a common interface between enterprise applications, so that data can be placed in a common event data structure. In that manner, a single interface can be built to each application. This single interface eliminates the requirement to build multiple interfaces between one enterprise application and other enterprise applications. This approach accommodates data sharing and reporting requirements that are known today, and provides the flexibility to accommodate likely unknown, and perhaps counter-intuitive, future requirements.

A second reason for using an event data structure is that it facilitates a piecemeal approach to establishing a private data network for sharing data between enterprises. Information can be shared quickly without requiring pre-defined business rules or global data definitions.

A third reason for using an event data structure is that it breaks down molecular data to the lowest atomic level. For instance, while enterprise application 200 may have recorded a single event for a group such as 18, the transactional event database records each processing event for each agricultural item separately, such as 10 and 11, so that a more complete history of the particular agricultural item may be established and shared. In this manner, the most specific information about a UOP may be maintained.

New Data Collection

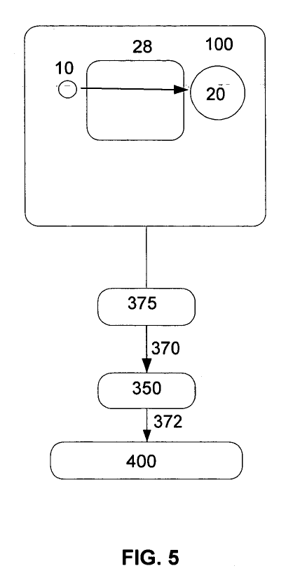

In this example, much of the data may be collected in a non-disruptive manner by extracting it from the enterprise application to one or more TEDBs as described above.

Where data is not available in an existing enterprise application, it may be collected as illustrated in FIG. 5 where a data collection device means 375 collects data 376 related to UOP 10 and process event 28. An on-ramp interface 370 is provided between the data collection device 375 and the shared communication 350. An on-ramp interface 372 is provided between the shared communication 350 and the TEDB 400. This structure is similar to the enterprise application communication, except that the communication is typically one-way to the TEDB. In other embodiments, two way communication can be used.

New data acquisition is typically automated or semi-automated such as through RFID or barcodes to read UOP identifiers associated with particular agricultural items; similar RFID or barcode identifiers for events, and direct electronic logging of event date and time and event detail. For instance, new data may be collected for a weighing measurement for an agricultural item by reading an RFID identifier for the item, reading a barcode for a measurement event of “weighing”, and directly logging a weight as the event detail. New data may also be collected manually, such as by the producer, and subsequently entered into one or more transactional event databases.

Sharing of Data from Another Enterprise Application

The attribute data for the agricultural item supports more informed processing decisions in downstream enterprises. It is also often desirable to have access to agricultural item attribute data which may have been generated, extracted, or collected at upstream enterprises. This sharing of information between enterprises or between enterprise applications is typically accomplished either by using the same transactional event database for the enterprise applications, or by using a series of such TEDBs in one or more private data network which include tools such as directories and data marts to efficiently share such information.

The PDN will typically include attribute data which was extracted from an upstream enterprise application. The PDN may share that attribute data to populate a portion of a different enterprise application.

Data Elements in Transactional Event Database

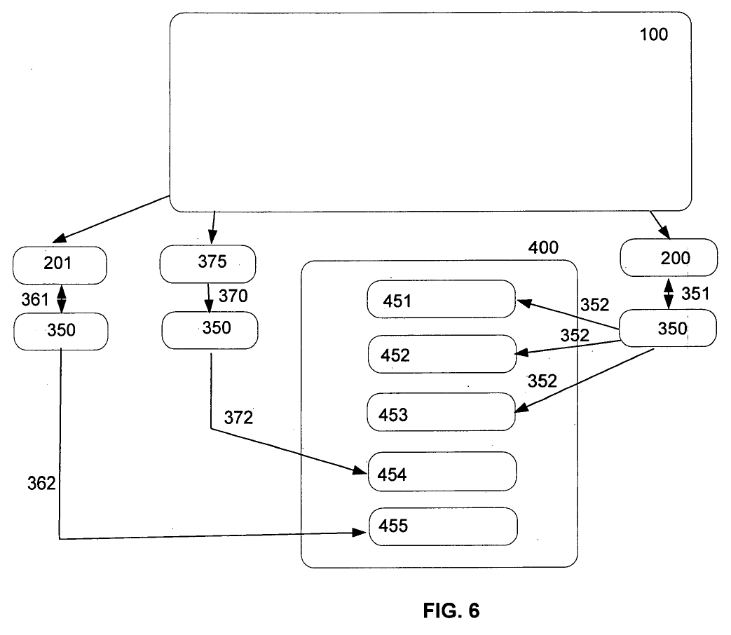

FIG. 6 is a representation of multiple rows of the transactional event database 400. In this example, rows 451, 452, and 453 of the TEDB are provided by interface 351 to enterprise application 200 to shared communication 350 and by interface 352 from the shared communication 350 to the TEDB 400. Row 455 is provided by interface 361 to enterprise application 201 to shared communication 350 and by interface 362 from the shared communication to the TEDB 400. Interfaces 352 and 362 typically include the on-ramp and off-ramp from the TEDB 400 to the shared communication 350 as described above. Interfaces 351 and 361 typically include the on-ramp and off-ramp from the enterprise applications 200 and 201 to the shared communication 350 as described above. Row 454 is provided by interface 370 from data collection device means 375 to shared communication 350 and interface 372 from the shared communication to the TEDB. In other embodiments, multiple TEDBs may be used to extract or collect data from enterprise 100.

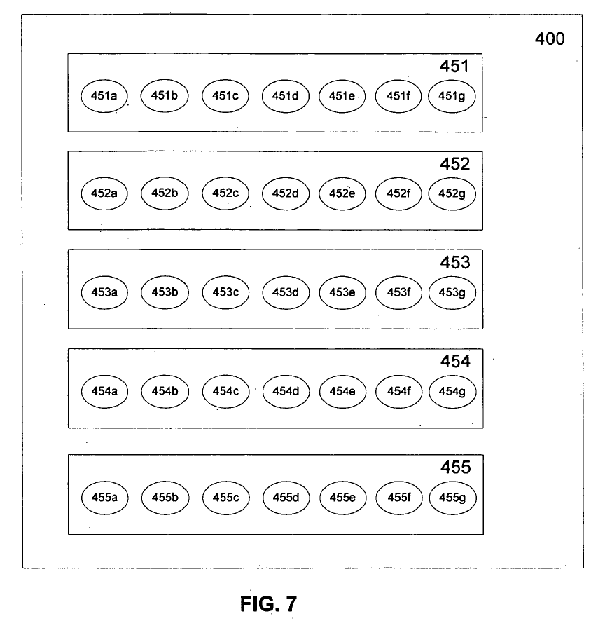

FIG. 7 is a representation of the data structure of the rows in a transactional event database 400. In this embodiment, each row has seven elements. The elements include five core events of an enterprise identifier, a unit of production identifier, a unit of production type description, an event type, and an event detail. As described below, this embodiment also includes the event date and time, and a parent event reference. In other examples, other elements may be used such as a global unique event identifier (GUID), a unit of measure for the event value, and additional data elements to provide security and audit functions.

The enterprise identifier is unique for a particular enterprise in the production flow for the agricultural item.

The unit of production type specifies a generic form of a unit of production. For example, in a wheat production flow, the unit of production type may include a seed lot; a farm field; a dough lot; a first harvesting container which may be linked by global positioning information to a particular portion of a farmer's field; a transportation container that transports the wheat to a storage location; a storage container that stores the wheat; a transportation container that transports the wheat to a mill, a storage or processing container at a mill, a milled flour container, or a lot of bread or other baked product produced from the flour. In the following discussion, the notation for a unit of production type is of the form container[xxx], transport[xxx], or equipment[xxx] where the “xxx” specifies a type of container, transport, or equipment.

The unit of production identifier specifies a particular unit of production. In the wheat example, for instance, the particular first harvesting container will have an identifier which is unique relative to other harvesting containers; the transportation container will have an identifier which is unique relative to other transportation containers; the storage container will have an identifier which is unique relative to other storage containers; the flour container will have an identifier which is unique relative to other flour containers; and the lot of bread will be unique relative to other lots. The unit of production identifier permits collection of attribute data for appropriately sized production and processing units of an agricultural item, and permits the tracking or reconstruction of the agricultural item through various forms in its production flow.

Examples of events include measurements, inputs, processing, transfers, and transformations. In this embodiment, an event may be a single activity. A parent event may be supported by additional details in one or more child event as illustrated in the wheat example below.

The event detail is the datum associated with the processing event, such as the weight determined in a weight measurement, a processing condition, or the identify of an enterprise where the item is being transferred. Other examples of event values include enterprise identifiers, unit of production identifiers, measurement values, and process parameters.

In some embodiments, the event date and-time is the date and time of the event occurrence. In other embodiments, the event date and time may be the time that the event was entered into an enterprise application which provides an approximation or estimate of the actual event date and time. This ability to expand or approximate an event time can be useful in tracing the history of a food product such as in a recall situation, or in providing data for statistical analysis. Such approximations of event times are often adequate for those purposes. In some embodiments the event date and time may be used to create a global unique identifier (“GUID”) for an event, such as by combining a universal time with a computer id. In this case, the date and time can be extracted from the GUID for analysis such as when a data mart is created. In other cases, approximations of event times or possible ranges of event times can be determined and stored.

Referring to FIGS. 6 and 7, in this example, a first row 451 includes an enterprise identifier for enterprise 100 as element 451a, a unit of production type as element 451b, a unit of production identifier for unit of production 10 as element 451c, a first event 451d related to process 18 for the unit of production 10, an event detail 451e, an event date and time as element 451f, and a parent event reference 451g.

Row 452 elements 452a-452g and row 453 elements 453a-453g are created by information from enterprise application 200 in a similar manner. These rows may represent additional events related to process 18, or may represent child events of the first event 451d such as additional detail. For instance event 451d may represent the application of a fertilizer, child event 452d may represent a type of fertilizer, and child event 453d may represent an application rate for the fertilizer.

Row 454 elements 452a-452g are created by information from enterprise application 201 in a similar manner. Row 455 elements 455a-455g are created by new data collection from data collection device 375.

Private Data Network

In this embodiment, the private data network includes at least one transactional event data base with high integrity data sharing to and from at least one enterprise application as illustrated in FIGS. 5 and 6. The private data network typically also includes at least one data mart which presents the event data in a useful form for decision support. An example of a data mart is presented in the wheat example below. The event data may be archived for future reference, and the data mart may include expression tools such as reports and charts. The private data network may also include a connection to a directory reference server to facilitate construction of data marts or other access to event data. The private data network may include a plurality of transactional event databases, a plurality of data marts, and additional layers of protocols, security, and services to permit transfer of data between the interfaces and the TEDBs.

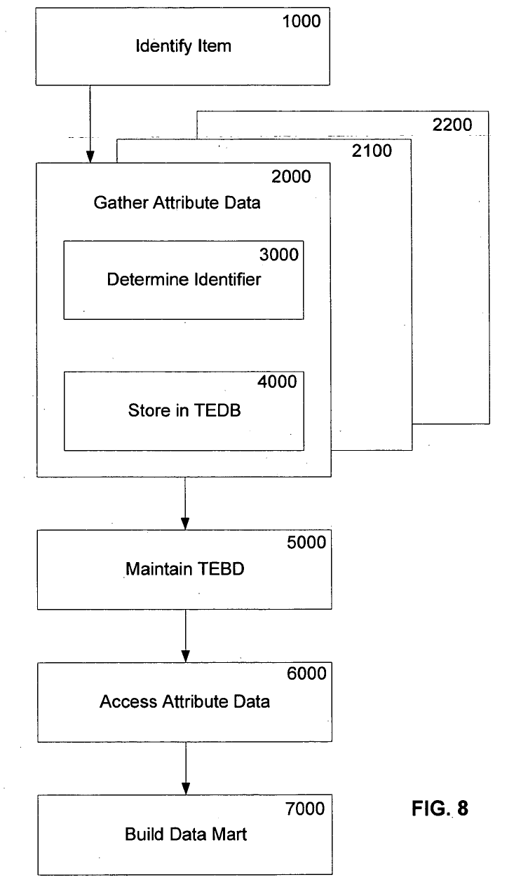

FIG. 8 represents a method of collecting and accessing attribute data in a private data network. At step 1000, the agricultural item is identified, such as item 10 of FIG. 6. At step 2000, attribute data is gathered by determining the agricultural item identifier at step 3000 and storing the enterprise identifier, unit of production type, unit of production identifier, event type, and event in a TEDB at step 4000.

An example of this gathering of attribute data at step 2000 is the gathering of event data is illustrated in FIGS. 6-7 by the collection of attribute event detail data 451e for event 451d related to process 18 from enterprise application 200. This gathering of attribute data is repeated for other rows of event data as indicated by steps 2100 and 2200. The collection of attribute event detail data typically includes determining the identifier for the UOP at step 3000, and storing the data in a transactional event data base at step 4000. The event data is maintained in at least one transactional event database at step 5000, as illustrated by the database 400 in FIGS. 5-7. At step 6000, the attribute data is typically accessed by referencing at least one of a unit of production identifier, an event type, an event detail, where the event detail may reference a different enterprise identifier or unit of production identifier. At step 7000, a data mart may be constructed from data in the TEDB, in order to improve the efficiency of referencing data.

### DETAILED DESCRIPTION OF EMBODIMENT

### Deconstruction of Data to Event Data Structure and Construction of Data Marts

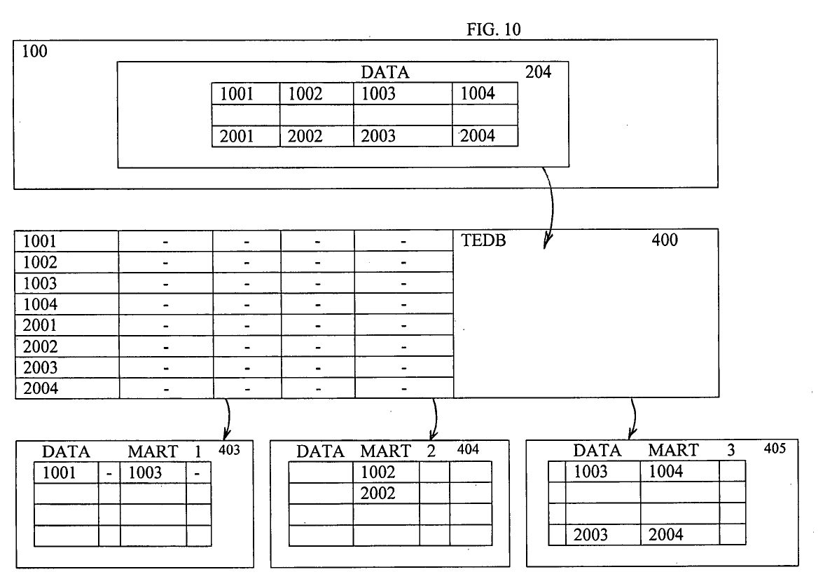

FIG. 10 represents the extraction of data from a data table 204 associated with an enterprise application for an enterprise 100. The data is extracted to a transactional event database 400, and the representation of that data into data marts 403, 404, and 405. In this example, a first row in the data table 204 includes cells containing attribute data 1001, 1002, 1003, and 1004. A second row in the data table includes cells containing attribute data 2001, 2002, 2003, and 2004.

In the transactional event data base, these cells are deconstructed so that each cell of interest is represented as a separate row of event data. The event rows typically include enterprise identification for the enterprise 100, a unit of production type which is typically associated with the data table name, a unit of production identifier which is typically determined from the row name in the data table, and event type which is typically determined from the column name for the cell of interest, and an event value which is typically either the value of the cell or derived from the value of the cell. Thus, in this example, each of the cells containing attribute data 1001-1004 and 2001-2004 are represented as separate event rows in the TEBD. In those cases where a row in the data table 204 may represent a collection of units of production, the TEDB will typically include multiple sets of rows such as those illustrated, with each set of rows corresponding to a discrete unit of production identifier which is part of the collection.

Data marts are typically constructed to address specific business questions. A data marts provides an efficient and condensed representation of the event data of interest to a business question. In the example of FIG. 10, data mart 403 presents the attribute data 1001 and 1003 representing a first unit of production at enterprise 100, and presents the attribute data 2001 and 2003 representing a second unit of production at enterprise 100. Other cells in the data mart may contain data from other units of production that typically include other unit of production types and other enterprises. Some of these additional cells may be determined from event data in other TEDBs. Data mart 404 includes attribute data 1002 and 2002. Data mart 405 includes attribute data 1003, 1004, 2003, and 2004, and illustrates that the same attribute data such as 1003 may be presented in multiple data marts.

Thus attribute data across multiple transfers between enterprises and multiple conversions of the form of the agricultural item can be represented concisely in a single table. This data mart representation is made possible and practical by the deconstruction of data from several enterprise application data tables as shown in this example. Where additional data collection is required, that data is collected through an event data structure in one or more TEDBs.

### DETAILED DESCRIPTION OF EMBODIMENT

### Wheat to Baked Goods Example

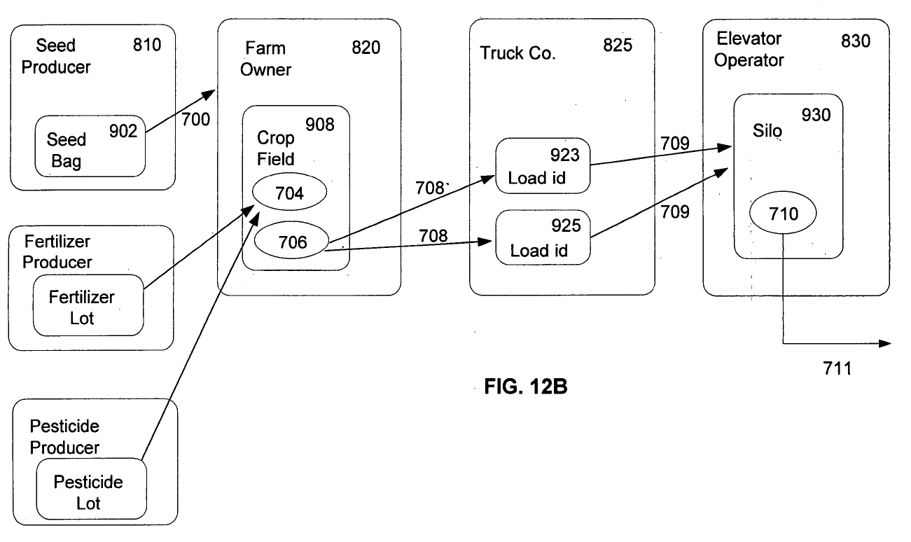

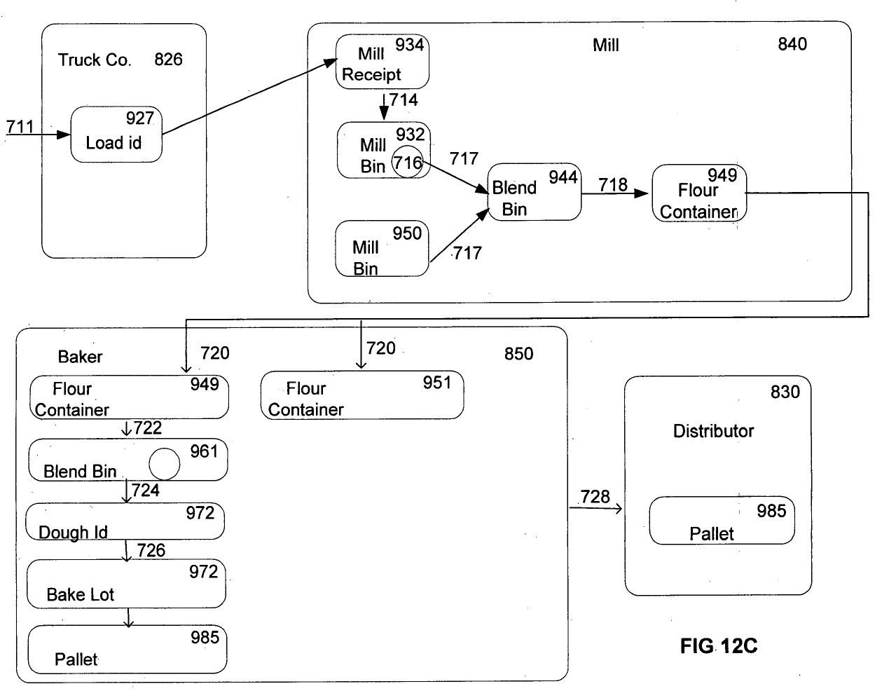

FIGS. 12A-12C, provide a simplified view of seed selection, planting, and growing of wheat; processing the wheat into flour, processing the flour into dough; and producing baked goods from the dough. This example illustrates one embodiment of the current invention.

In this example, the business problem to be addressed is to determine the relationship between processing and quality characteristics of a baked product such as buns, and the variety of wheat and growing location of the wheat which is used to produce the flour and dough for the baked product. Other business questions may be addressed in a similar manner, and those questions may require data from a single enterprise or from multiple enterprises in the production flow of the agricultural item.

The example illustrates the tracking of processing and quality characteristics of the agricultural products across various owners and enterprises from the seed producer to the baked goods distributor. The form of the unit of production in this example changes from a bag of seed to a crop field to various containers of harvested wheat, to flour containers, to dough lots, to a baked goods lot, and to a pallet or package of baked goods at a distributor.

The tracking may include processing characteristics and attributes such as whether the seeds are of a genetically modified variety, the location of the field where the wheat is grown, the pesticides or fertilizers applied to the field, the moisture content and analysis measurements at a silo and at other processing or storage points, or a particular amino acid content. Other types of information may be tracked as illustrated by this simplified example.

Production Flow

As indicated in FIG. 12A, several processing steps are shown in the example in order to illustrate the capture and analysis of data across multiple enterprises and multiple forms of production. In this example, the enterprises include an input supplier, the seed producer 810; a producer, the farm owner 820; a first trucking company 825; an aggregator, the elevator operator 830; a second trucking company 826; a first stage processor; the flour mill 840; a second stage processor, the baker 850; and a distributor 860. This example could be expanded to represent N-stage processors, Logistics/Distributor, and Retail/Food services enterprises in more typical distribution and end customer activities.

FIGS. 12B-12C are more detailed production flow diagram. In this example, the processing steps include purchasing seed at step 700; planting the seed at step 702; growing the crop at step 704; harvesting the wheat at step 706; loading trucks with the grain at step 708; receiving the grain at an elevator at step 709; elevator operations at step 710; loading a truck from the elevator at step 711; shipping the grain to a mill at step 712; receiving the grain at the mill at step 714; processing the mill bin at step 716; blending grain at step 717; milling the grain at step 718; shipping flour to a baker at step 720; processing the flour at step 722; preparing dough at step 724; baking at step 726; and shipping a pallet of baked goods to a distributor at step 728. This example could be continued to represent more typical distribution and end customer activities.

Each unit of production of an agricultural item may have a form of measurement or identification which is different from other units of production. For instance, at various points in the production flow, a unit of production may be a bag of seed, a field of grain, a container of grain, a pallet of baked goods, or other forms. In some cases, these various forms of measurement may represent changes in quantity from a first unit of production such as a harvestor load to a second unit of production such as a truck load. In other cases, the forms of measurement may represent physical or chemical changes such as grinding of wheat to a flour, or conversion of flour to a dough.

FIGS. 12B-12C show several points in the production flow where there is a quantity conversion in the unit of production of the agricultural item, such as hauling the harvest in several truckloads at step 708; combining truckloads to a silo at step 710; removing a portion of the elevator contents at step 711; blending grain into a blend bin at step 717; and blending flour into flour bins at step 722.

FIGS. 12B-12C also show several physical or chemical transformations or conversions of the agricultural item from one unit of production to another unit of production. The units of production include a seed lot 902; a farm field 908; a truckload 923 and 925; a grain elevator or silo 930; a truckload 927; mill bins 932 and 950; a mill blend bin 944; a flour container 949 and 961; a bakers blend bin 973; dough lots 972 and 974; a bake lot 972; and a pallet of baked goods 985. One aspect of the current invention is the ability to track the agricultural item through such changes in form of units of production and changes in quantity of those units.

Data Structure

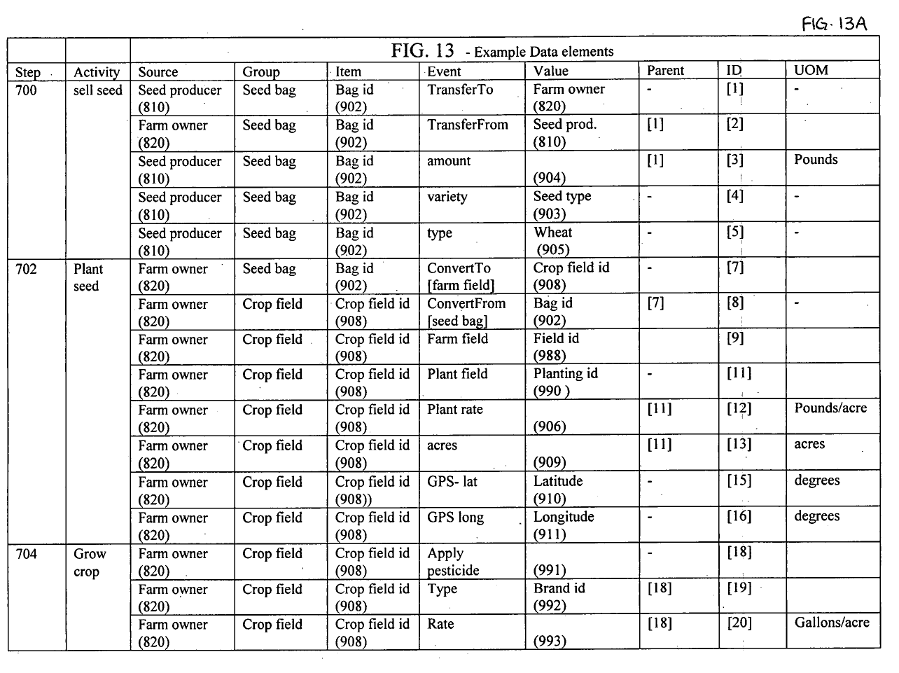

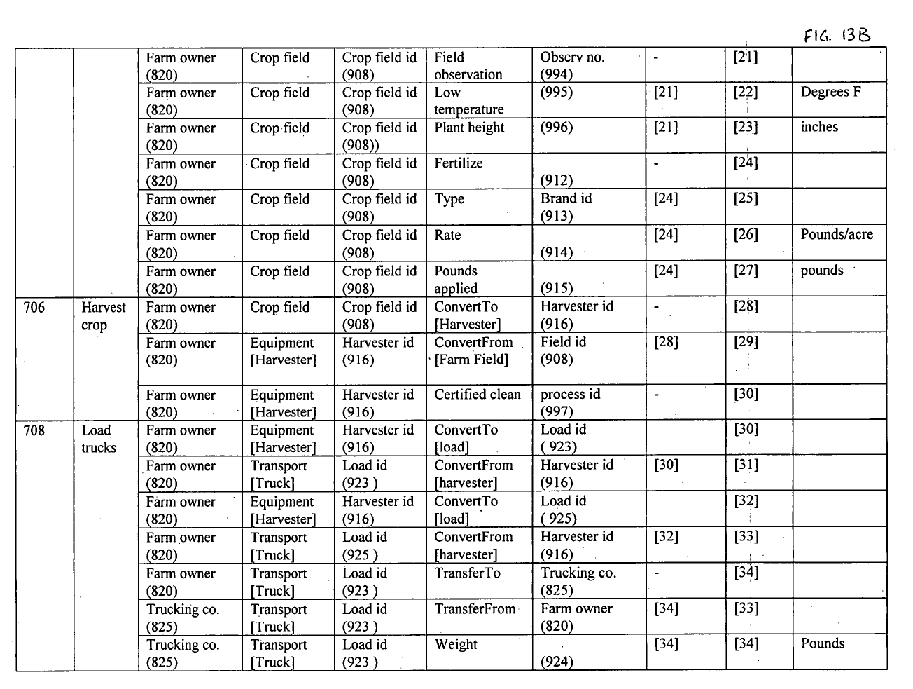

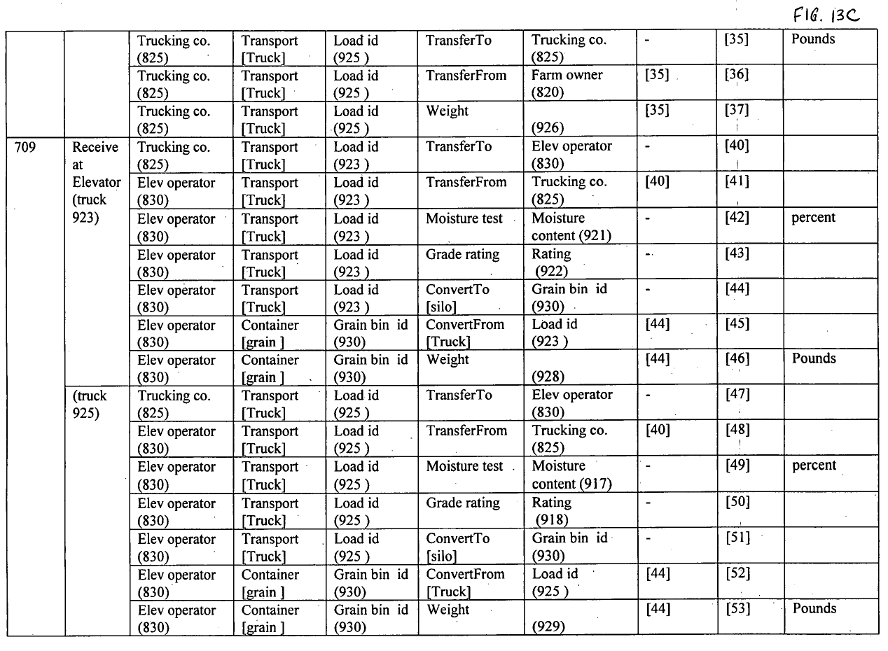

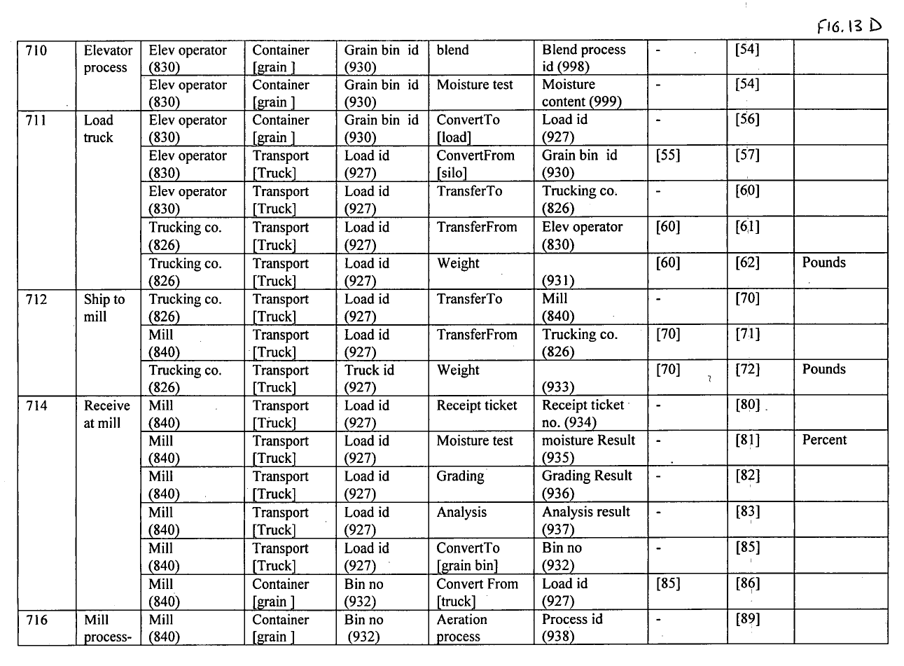

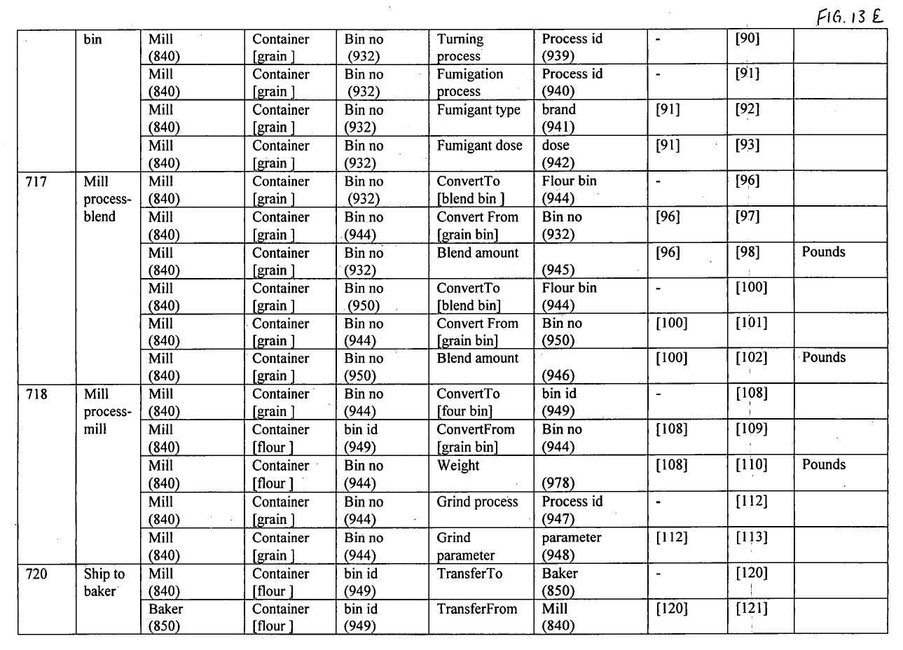

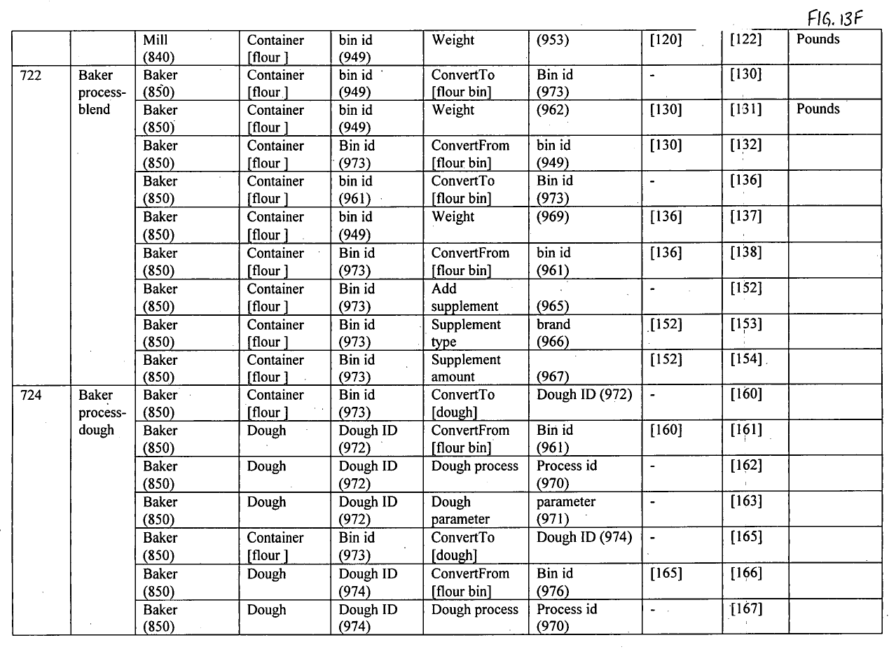

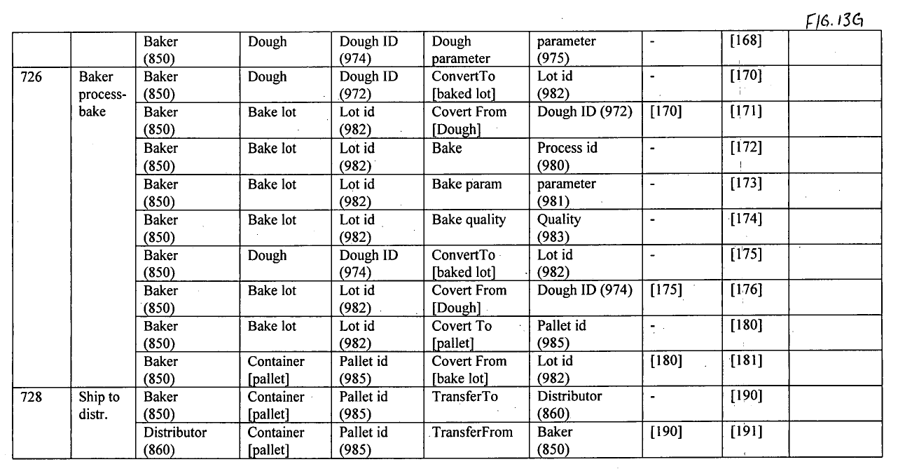

FIG. 13 is a table for a limited example which illustrates a data structure which can be used to track an agricultural item such as in this wheat example. The table includes two columns on the left for step number and activity. These columns are not part of the data structure, and are included to provide a reference for this example. The data elements of this example include the eight columns on the right of the table for Source, Group, Item, Event, Value, Parent id which is the parent event identifier, a global unique identifier (GUID), and a unit of measure (UOM). Each activity in the production flow is represented by one or more events, and each event is represented in the table as at least one row. This example does not include a comprehensive listing of all events in the production flow.

For example, at step 700; which is the purchase (or sale) of seed, the first row in the table has an entry for a seed producer 810 transferring a particular bag of seed 902 to a farm owner 820. The GUID is simplified here to be “[1]”. In practice, this identifier is a long alphanumeric sequence, such as derived from the time of the event and a particular computer id, in order to assure a unique identification. In general the GUIDs need not be sequential in nature as in this example. There is no unit of measure for this first event.

In this embodiment, a “transfer to” event where the event detail is another enterprise automatically creates a corresponding “transfer from” event from the receiving enterprise. For example, the second row (GUID=[2]) is another parent event where the source is the farm owner 820; the event is “transfer from”; and the value is seed producer 810. For convenience of this discussion, the rows are identified by their GUID. In this example, the GUIDs are presented generally sequentially for convenience of reference.

In this example, the first row does not a have a parent id because it is the high level event. In the second row, a separate event [2] is created for a corresponding “TransferFrom” event. The event [2] has a parent id of [1]. In other embodiments, the TransferFrom event may not be created. In this example, the TransferFrom event is created as a child event of the TransferTo event. In other embodiments, the TransferFrom event may be a parent event.

The next three rows for seed variety, seed type, and seed amount are also represented as child events of the first event. For instance, the third row shows an event [3] “amount” and an event detail of seed type 903. This seed variety event shows a parent id of [1] which is the first event GUID. Each child event has a separate GUID. Row [4] shows an event “variety” and an event detail the weight 904. In this row, a unit of measure, pounds, is provided. Row [5] has an event “type” and detail wheat 905. In this example, the variety of seed could be a genetically modified or a non-genetically modified seed type 903. A corresponding business question could be the need to create a listing of what agricultural products are available with the attributes of high lysene content and a non-GMO variety.

Step 702 represents the planting of a crop field which may be a part of a larger farm field. At [7] a “ConvertTo” event is used with an identifier of “farm field” and an event detail of a particular crop field 908 which is uniquely identified. The “ConvertTo” event type is used when the unit of production changes. In this example, the unit of production changes from a bag of seed to a crop field. The identifier of “farm field” is used in this embodiment to improve the efficiency of the use of the event data. In other embodiments, the identifier may be presented as a child event or as a separate parent event. In this example, a corresponding “ConvertFrom” event is created as a child event at [8] when the “ConvertTo” event is recorded. In other embodiments, the “ConvertTo” event may be presented as a parent event, or it may not be created. At [9] the crop field 988 is associated with the farm field 908. At [11] a planting parent event is created, and child events for plant rate and number of acres are created at [12] and [13]. Representative global positioning coordinates are shown at [15] and [16]. Various representation schemes may be used such as a center point, or comers of a field. This location permits correlation of subsequent product attributes with field location. The field location may be correlated with other geographic or weather information, so that additional analysis may be conducted.

Step 704 represents the growing of a crop in the crop field. Representative events at this stage include pesticide application at [18] with child event details [19] and [20]; fertilizer application at [24] with child event details [25], [26] and [27]; and field observations or measurements such as [21] where low temperature [22] and plant height [23] are shown.

Step 706 represents the harvesting of the crop from the crop field. A “Convert To” parent event is created at [28] to identify a particular harvester 916. A corresponding “ConvertFrom” child event at [29] links the crop field 908 to the harvester. At [29], the unit of production type is shown as “Equipment [Harvester]”. Many unit of production types can be represented as equipment, containers, or transport. Since it is desirable to have unique unit of production identifiers, this nomenclature only requires that a class of unit of production identifiers, such as harvesters or grain silos, be unique, so that the same identifiers could be duplicated on other classes of units of production. In this example, the clean harvester event at [30] is representative of linking additional processing history to a unit of production. In this example, the Group types are simplified to be Container, Transport, and Equipment. This taxonomy is not unique, and other classifications of Groups may be used. If there is a possibility of duplicating item identification, then these groups can be made more specific by introducing a descriptor with the type name such as Container[grain] or Container[flour].

Step 708 represents loading transport truck loads 923 and 925 from the harvestor 916. These events include both “ConvertTo” events at [30] and [32] and “TransferTo” events at [34] and [35]. In this embodiment, a “TransferTo” event is used when a unit of production moves from one enterprise to another such as from the farm owner 820 to the trucking company 825. “ConvertTo” events are used when the unit of production type changes within an enterprise. Other representation schemes may be used in other embodiments.

Step 709 represents receiving the transport truck loads 923 and 925 at an elevator. This step includes “TransferTo” events at [40] and [47] with corresponding child events for moisture content and other analysis. A “ConvertTo” event at [44] tracks the truck load id 923 to a particular silo grain bin 930. A similar “ConvertTo” event at [52] tracks the truck load id 925 to a particular silo grain bin 930.

Step 710 represents elevator processes such as blending at [54] and moisture test at [55].

Step 711 represents loading transport trucks at the elevator operator 830 and transferring ownership to the trucking company 826. The unit of production type is converted from a grain bin 930 to a transport truck load 927 at [56] and transferred to the trucking company at [60].

Step 712 represents shipping the transport truck load 927 to a mill 840. There is no conversion of unit of production type, so only a “TransferTo” event is shown at [70].

Step 714 represents receipt of the transport truck load 927 by the mill 840. In this example, the mill creates a receipt ticket 934 at [80] and performs tests on the load at [81]-[83]. At [85] the transport load id 927 is converted to a grain bin 932.

Step 716 represents mill processes that do not change the unit of production type, including aeration at [89], turning at [90], and fumigation at [91]-[93].

Step 717 represents the blending of two grain containers 932 and 950 to a grain bin 944. The blending is recorded as “ConvertTo” events at [96] and [100].

Step 718 represents the milling of the grain in grain bin 944. The milling is represented by a conversion to a flour bin 949 at [108] including a child event for weight at [110], and by grind process details at [112]-[113]. The grind process has a process id 947 and may have process parameters such as grind parameter 948.

Step 720 represents transferring the flour bin 949 from the mill 840 to a baker 850. The transfer events are recorded at [120]-[122].

Step 722 represents a blending by the baker of flour bins 949 and 961 to a blend bin 973. The blending is represented by conversion events at [130]-[138]. After blending, a supplement is added to the blend bin at [152]-[154].

Step 724 represents converting the flour in blend bin 973 into dough lots 972 and 974. The “ConvertTo” events are at [160] and [165], and the dough process is recorded at [162]-[163] and [167]-[168].

Step 726 represents baking the dough lots 972 and 974 to a bake goods lot 982. The “ConvertTo” events are at [170] and [175], and a representative bake process is recorded at [172]-[174]. The bake lot is converted to one or more pallet id such as 985 at [180].

Step 728 represents shipping the pallet id 985 to a distributor 860. A “TransferTo” event is recorded at [190].

Data Mart and Analysis

This example demonstrates the tracking of an agricultural item through various transformations across different segments of production and different enterprises by permitting the recording at each stage of transformation a source, a group, an item, an event, a value or attribute, a parent id, a global unique identifier (GUID), and a unit of measure (UOM). Other examples may record different data elements.

The business objective of this example is to correlate a bake lot quality attribute 983 with other agricultural item attributes at other earlier stages on production. For instance, in this example, the bake lot quality attribute 983 may be correlated with information such as the variety or varieties of grain used in the flour; the location of the farm fields where that grain was grown and environmental conditions related to the growing of the wheat; measured attributes of the wheat at harvest, in the elevator, or at the mill; supplements or other agents added to the wheat or flour; and grinding, baking, and other processing conditions.

Examples of other business objectives include the tracking of yield factors across a single enterprise; and the identification of the availability of agricultural items with particular. characteristics, such as non GMO corn with a high lysene amino acid content.

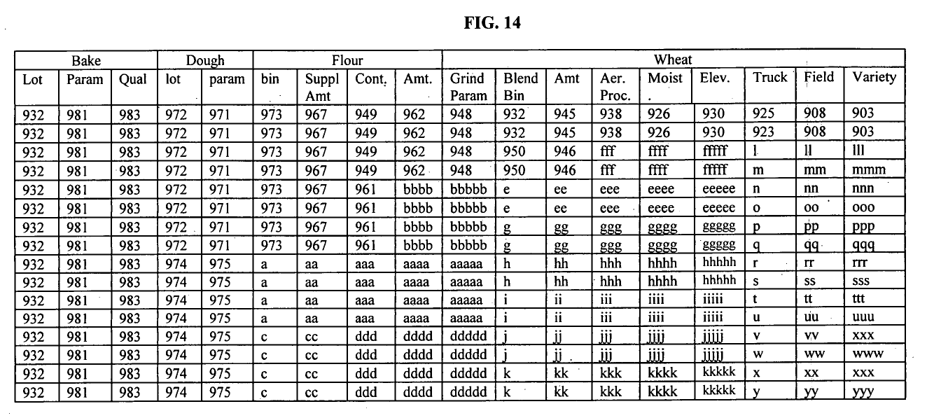

Typically the analysis is conducted from data assembled in a data mart from one or more TEDB as illustrated by FIG. 14A which is a simplified example of a data mart for the wheat example to address the business question of relating a baked goods quality attribute 983 to upstream process parameters or item attributes. In this example, the first two rows of the table are headings which are not typical of the data structure of a data mart. The example is a flat file cross tabulation representation. Other data structures may be used in a data mart.

This example shows multiple rows for a single bake lot 932 in order to represent several blendings of materials that eventually were used in the bake lot. For instance, the bake lot 932 includes dough from two dough lots, 972 and 974. Each dough lot may have flour from more than one container as illustrated by flour containers 949 and 961 which were blended to flour bin 973 which was used to create dough lot 972. Each flour container may include flour ground from more than one grain bin as illustrated by grain blend bins 932 and 950 used for flour containers 949. Each grain blend bin may have grain from more than one truck load from the crop field as illustrated by loads 925 and 923 used in elevator silo 930. FIG. 14 illustrates a compilation of event data for the various harvested crop truck loads which could have been used in the bake lot. The upper portion of the table includes specific element reference numbers as shown in FIG. 13. The lower portion of the table is filled with dummy variables a, aa, aaa, aaaa, etc to represent the various blending points.

In this simplified example, the first three entries for the first row in the table include the bake lot id 932, a bake process parameter 981 such as oven temperature, and a bake product quality attribute 983. These values are extracted from one or more transactional event data base of the example in FIG. 13. The next two entries are representative of agricultural item identification and attribute data for the dough which was used in the bake product. The bake lot is a transformation of the dough agricultural item, and the data mart can provide the tracking across that transformation so that information such as the dough lot 972 and a dough process parameter value 971 may be presented for analysis. In a similar tracking, information about the flour which was used in the dough can be presented. In this example, the flour information includes a flour bin 973, a supplement amount 967, a container 949, and an amount used 962 from a container 949. In this example, the flour container 949 comprises wheat ground from blend bin 932 and blend bin 950, information for each of those bins is included as a pair of separate rows. Two rows are used to track bin 932 in this example because two different truck ids, 925 and 923, could have contributed wheat to that bin.

Information about the wheat units of production include a grind process parameter 948, blend bin numbers 932 and 950 and corresponding amounts 945 and 946 from those bins, the aeration process 938, moisture content 926, the elevator number 930, harvest truckload identifiers 923 and 925, the farm field 908, and the wheat variety 903. Other process parameters through the production flow could have been included in the data mart, as well as additional data attributes such as other direct measurements of unit of production attributes or indirectly obtained attributes such as fertilizer or weather conditions at the farm field.

In this example, if the data establishes that a particular grain variety improves the baked product quality attribute, the baker can adjust purchasing practices to solicit that preferred variety of wheat. This identification of a particular variety represents a de-commoditization of the wheat.

In this example, it is generally not practical to track a specific baked item such as a bun to a particular earlier unit of production such as a crop field.

Despite this lack of certainty, there are several benefits to this tracking approach. One benefit is the ability to rapidly and substantially narrow the range of possible sources of an agricultural item. For instance, while it may not be possible to identify a single silo, there are a limited number of silos that could contribute grain to a baked product. The ability to narrow the list of possible sources is obviously useful in a recall situation, but it also useful in the analysis of large amounts of data to detect sources of variation in quality. This approach supports continuing quality improvement and the de-commoditization of agricultural items of production. The example also illustrates an effective and practical approach to establishing the capability of tracking an agricultural item across multiple enterprises and multiple forms of production. This capability, in turn, can accelerate the trend toward unique identification and data collection for discrete units of production throughout the production flow. As the information becomes more discrete, the ability to track will become more precise. A useful system requires both discrete unit of production identification with associated data collection, and the ability to do something useful with that information.

### DETAILED DESCRIPTION OF EMBODIMENT

### Private Data Network System with Additional Data Elements to Support Audit and Security Functions

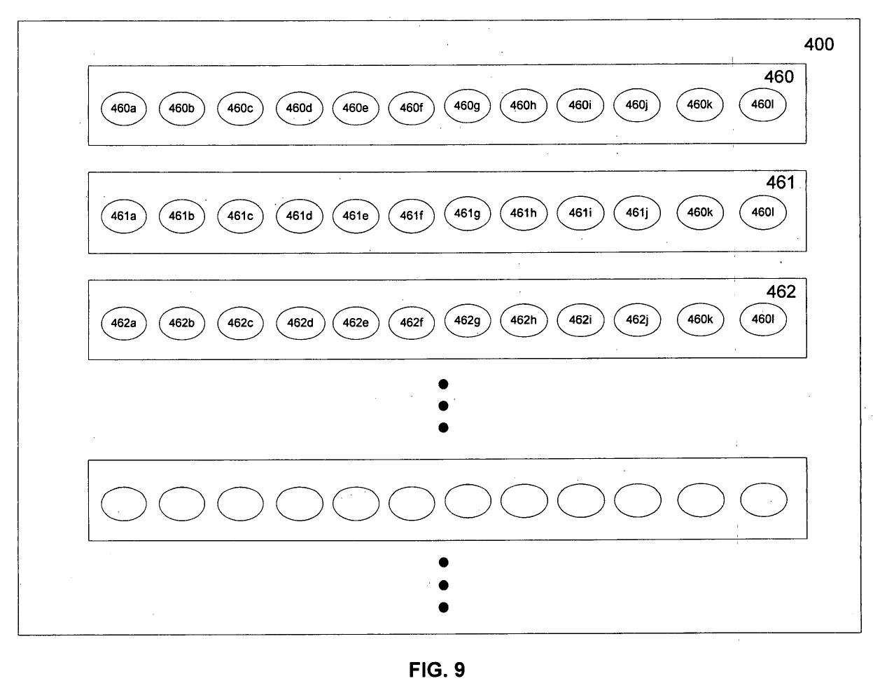

FIG. 9 is a representation of a transactional event database with additional data elements to facilitate auditing and tracking across multiple enterprises and multiple forms of unit of production. In this example, the transactional event database 400 has a first row 460 which includes the first seven elements 460a-460g as discussed above—an enterprise identifier 461a, a unit of production type 461b, a unit of production identifier 461c, an event type 461d, an event detail 461e, an event time 461f, and a parent id 461g.

In this example, the first row 460 also includes element 460h for unit of measurement, 460i for and audit date, element 460j for security, element 460k for a record entry mode, and element 460l for sequence number.

The audit date 460i is the date the record is entered into the database. The security 460j may be similar to a check sum, or a tamper element tag for all of the other elements in a record. The record entry mode 460k is a description of the method by which data enters, such as the source system that collected the data. The sequence number 460l is typically a sequential number that permits detection tampering with the data, such as removing or adding records.

Some or all of these elements may be recorded in databases, depending upon desired objectives. For instance the enterprise id and the unit of production identifier permit collection and sharing of attribute data across multiple enterprises and multiple forms of production. The audit data, record entry mode, and sequence number enable tamper-evident auditing of the data.

### DETAILED DESCRIPTION OF EMBODIMENT

### Distributed Transactional Event Databases

The wheat example above illustrates extracting or collecting event data for an agricultural item as the item is processed through a plurality of enterprises and forms of units of production. In practice, this event data may be collected into several different transactional event databases and then compiled into data marts from the various TEDBs. The support of multiple transactional event databases gives enterprises control of their data and facilitates security and authorization level control for access to the data. An enterprise typically may collect much more event data than is interesting to other upstream or downstream entities. The enterprise can control and utilize-that more specific information and share only that portion of the data which other enterprises are entitled to receive.

### Populating Data to Enterprise Applications

The interface to the TEDBs can also be used to populate data into the enterprise applications in order to minimize data entry. In addition to interfacing with existing applications, the event data can be used in new correlation analysis tools such as statistical process control and statistical analysis to determine relationships between attribute data and quality factors or performance at an enterprise. The data can also be used to allocate costs of production to individual units of production so that the true costs of agricultural item attributes can be determined. As illustrated in examples below, knowing the cost impact of attribute data can permit an enterprise to pay a premium or to discount prices for agricultural items based on the attribute data. There is a variation, and sometimes a large variation between different units of production of an agricultural item, and those variations can be identified, measured, and managed to improve operational efficiency, product quality, and profitability.

### DETAILED DESCRIPTION OF EMBODIMENT

### Incremental Building of Loosely Linked System of Private Data Networks

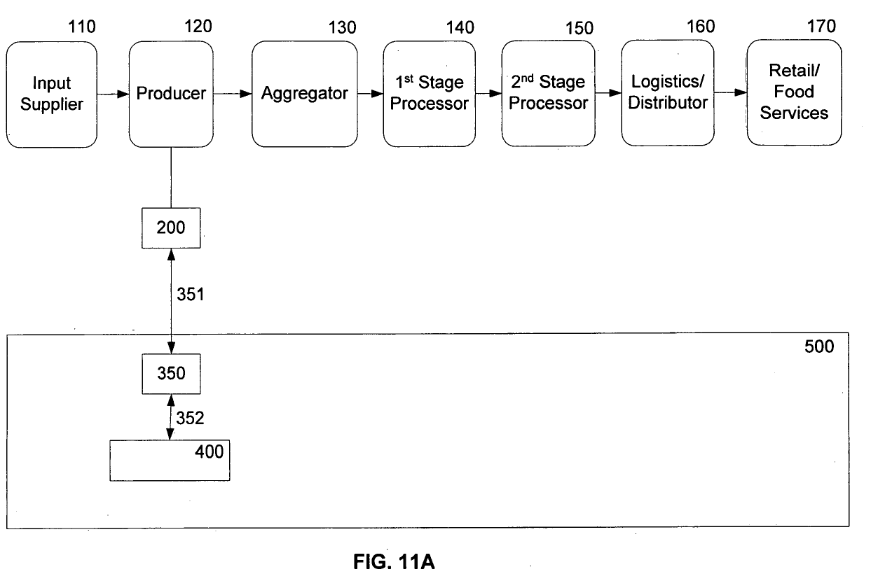

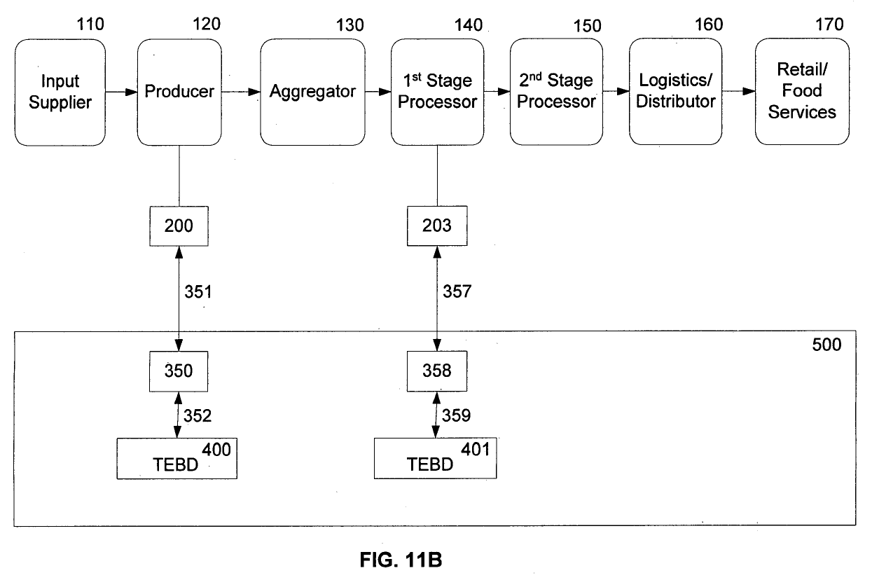

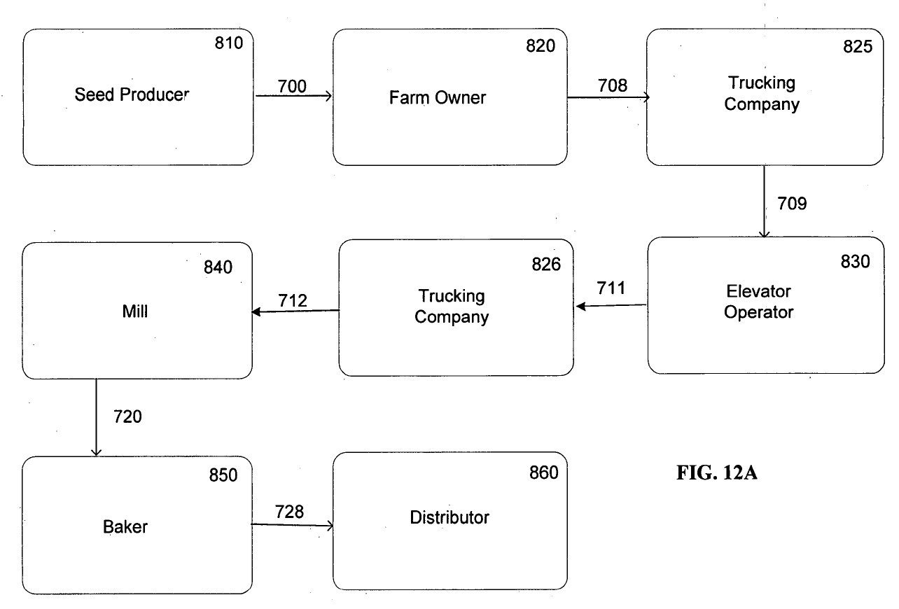

Referring now to FIG. 11A, the private data network can be built incrementally by starting at a single enterprise or enterprise application. In this example, data is extracted from enterprise application 200 associated with enterprise 120. As described above, the interface 350 establishes application communication 351 and backbone communication 352 in order to transfer event data to the TEDB 400. This example is simplified, and does not show additional data collection or other enterprise applications associated with the enterprise. These other data sources can be added at a later date. This stage of the implementation can be accomplished without knowing how the event data will be used by the other enterprises. By contrast, relational databases and other traditional approaches typically require considerable planning, data definition, and consideration of business rules before they can be implemented.

### Incremental Building of a Shared Network

Referring now to FIG. 11B, the private data network can be expanded incrementally by starting at another enterprise or enterprise application. In this example, data is extracted in a similar manner from enterprise application 203 to a second TEDB 401. As before, other data sources such as other enterprise applications and other data collection devices may also be interfaced to the TEDB 401, or to another TEDB.

### DETAILED DESCRIPTION OF EMBODIMENT

### Protocols or Combinations of Events

In many cases it is desirable to confirm that the processing history of a particular agricultural item conforms to a protocol or standard. For example, agricultural products which are labeled “organic” should be produced according to organic production practices. A customer should be able to determine whether a fiber product such as clothing was produced with child or slave labor. A customer should be able to determine that coffee conforms to Fair Trade Coffee guidelines where the grower was paid a fair price; or that a product was produced with fair labor practices. These types of protocols represent many events over portions of the production cycle. In such cases a data mart can be constructed to collect process information regarding the desired processing conditions for each different segment of production and this data mart can be referenced by subsequent potential buyers. Alternately, the data can support certification of a product as conforming to a standard.

### DETAILED DESCRIPTION OF EMBODIMENT

### Identification Methods

A unit of production may be identified by one or more techniques including an RFID device; a bar code; a biometric device or technique including DNA; a visual technique such as appending an image of a truck license plate with a date to identify a grain delivery at a flour mill; or an automatic sequencing system such as assigning a different sequence number periodically, such as every minute, to partition the grain into smaller units of production.

What is claimed is:

1. A private data network system for sharing attribute data for an agricultural item between a plurality of enterprises in a production flow for an agricultural item, the private data network system comprising
at least one private data network, the private data network comprising
at least one transactional event database, such that the transactional event database stores agricultural processing event information related to the agricultural item, the transactional event database having a plurality of entries, the entries comprising plurality of transfer events where the agricultural item is transferred from a first enterprise to a second enterprise, and a plurality of conversion events where the agricultural item is converted from a first unit of production to a second unit of production, each entry comprising
an enterprise id associated with an enterprise,
a unit of production type,
a unit of production identifier,
an event type associated with a processing event at the enterprise, and
an event detail associated with the event type, and
a data communication means between an enterprise application associated with an enterprise and the transactional event database.

2. The private data network system of claim 1 wherein data communication means between an enterprise application and the transactional event database further comprises
a shared communication means;
an on-ramp means for sharing data from the shared communication means to the transactional event database;
an off ramp-means for sharing data from the transactional event database to the shared communication means;
an on-ramp means for sharing data from the shared communication means to the enterprise application; and
an off ramp-means for sharing data from the enterprise application to the shared communication means.

3. The private data network system of claim 1 further comprising
at least one data mart, such that the data mart comprises a portion of the information from at least one transactional event database.

4. The private data network system of claim 1 wherein the private data network further comprises
a plurality of transactional event databases.

5. The private data network system of claim 1 further comprising
a plurality of private data networks.

6. The private data network system of claim 1 wherein the transactional event database further comprises
a date and time associated with the event.

7. The private data network system of claim 1 wherein the transactional event database further comprises
an event parent identifier;
a global unique event identifier, and
a unit of measure.

8. The private data network system of claim 1 wherein the transactional event database further comprises
an audit date;
a security field;
a record entry method; and
a sequence number.

9. The private data network system of claim 1 wherein the conversion events comprise
a transformation of the quantity of an agricultural item from a first unit of production to a second unit of production.

10. The private data network system of claim 1 wherein the conversion events comprise
a transformation of at least one physical characteristic of the agricultural item from a first unit of production to a second unit of production.

11. The private data network of claim 1 further comprising
a means for extracting data from the enterprise application; and
a means for storing the extracted data in the transactional event database.

12. The private data network of claim 1 further comprising
a means for collecting event data associated with at least one enterprise; and
a means for storing the collected data in the transactional event database.

13. A method for gathering and sharing agricultural item attribute data in a private data network, the method comprising:
identifying, with a unit of production identifier, a discrete unit of a unit of production type of the agricultural item at a first enterprise;
maintaining at least one transactional event database for the agricultural item;
gathering attribute data for a plurality of agricultural item processing events, by, for each processing event,
determining at least one attribute data element associated with the processing event, and
storing, in an entry of the transactional event database,
an enterprise id for the enterprise,
the unit of production type,
the unit of production identifier,
an event type for the processing event,
an event detail for the processing event, such that the event detail comprises attribute data, and
a time associated with the processing event,
accessing at least a portion of the attribute data for the agricultural item by referencing at least one of the event type, the event detail, the unit of production type, the unit of production identifier, the enterprise id, or the time associated with the event.

14. The method of claim 13 wherein identifying, with a unit of production identifier, a discrete unit of a unit of production type of the agricultural item at an enterprise comprises
assigning a unique identifier selected from the group consisting of RFID, bar code, biometric, visual, and automatic sequencing systems.

15. The method of claim 13 further comprising
acquiring new attribute data at a first processing event at the first enterprise by determining a first unit of production identifier associated with the first processing event, and
storing, in an entry of a first transactional event database,
an enterprise id associated with the first processing event,
a first unit of production type,
the first unit of production identifier,
a first processing event type,
a time associated with the first processing event; and
extracting processing event attribute data from an enterprise application for a second processing event at a second enterprise by
determining a second unit of production identifier associated with the second processing event, and
storing, in an entry of a first transactional event database,
an enterprise id associated with the second processing event,
a second unit of production type,
the second unit of production identifier,
a second processing event type,
a time associated with the second processing event.

16. The method of claim 15 wherein extracting processing event attribute data from an enterprise application further comprises
querying the enterprise application to return agricultural item attribute data from a database table, the database table comprising at least one row and a plurality of columns, the row and columns defining a plurality of data cells, such that the row has a row identity and the columns have a column identity; and
creating a processing event transaction for a data cell by
determining an enterprise id,
determining a unit of production type,
determining a unit of production identifier from the row identity,
determining an event type from the column identity,
determining an event detail from the cell value,
determining a time associated with the event detail, and
storing within a row of at least one event transactional database,
the enterprise id,
the unit of production type,
the unit of production identifier,
the event type,
the event detail, and
the time.

17. The method of claim 13 further comprising
storing, in a row of at least one transactional event database, additional data security information selected from the list consisting of an audit date, security, record entry method, and sequence number.

18. The method of claim 13 further comprising
storing, in a row of at least one transactional event database an event parent identifier.

19. The method of claim 13 further comprising
identifying, with a first unit of production identifier, a first discrete unit of a first unit of production type of the agricultural item at the first enterprise;
maintaining first transactional event database for the agricultural item;
gathering attribute data for a plurality of agricultural item processing events, by, for a first processing event,
determining attribute data associated with the first processing event, and
storing, in a row of the first transactional event database,
an enterprise id for the first enterprise,
the first unit of production type,
the first unit of production identifier,
an event type for the first processing event,
an event detail for the first processing event, such that the event
detail comprises attribute data, and
a time associated with the first processing event;
identifying, with a second unit of production identifier, a second discrete unit of a second unit of production type of the agricultural item at a second enterprise;
maintaining second transactional event database for the agricultural item; and
gathering attribute data for a plurality of agricultural item processing events, by, for a second processing event,
determining attribute data associated with the second processing event, and
storing, in a row of the second transactional event database,
an enterprise id for the second enterprise,
the second unit of production type,
the second unit of production identifier,
an event type for the second processing event,
an event detail for the second processing event, such that the event
detail comprises attribute data, and
a time associated with the second processing event.

20. The method of claim 19 further comprising
creating at least one data mart from the information in the transactional event database; and
accessing at least a portion of the attribute information for the agricultural item by querying the data mart.

21. The method of claim 13 further comprising
gathering data for at least one agricultural item processing event representing
converting the agricultural item from a first unit of production to a second unit of production, such that
the unit of production type represents the first unit of production,
the event type represents the conversion of the unit of production from the first unit of production type to the second unit of production type, and
the event detail represents the second unit of production type.

22. The method of claim 21 further comprising
locating a first event having an event type representing a conversion of unit of production, and having an event detail representing the unit of production for the second enterprise;
determining from the first event the unit of production type for the first unit of production; and
accessing at least a portion of the attribute data for the agricultural item in the first unit of production by selecting a second event having a unit of production type which represents the first unit of production.

23. The method of claim 21 wherein converting the agricultural item from a first unit of production to a second unit of production comprises
changing the quantity of the agricultural item.

24. The method of claim 21 wherein converting the agricultural item from a first unit of production to a second unit of production comprises
changing at least one physical characteristic of the agricultural item.

25. The method of claim 13 further comprising
collecting, into the private data network, agricultural item attribute data from a first enterprise, where the agricultural item is in a first unit of production; and sharing the agricultural item attribute data from the first enterprise with a second enterprise application, where the agricultural item is in a second unit of production.

26. The method of claim 13 further comprising
gathering data for at least one agricultural item processing event representing transferring a unit of production of the agricultural item from a first enterprise to a second unit enterprise, such that
the enterprise id represents the first enterprise,
the event type represents the transfer of the unit of production from the first enterprise to the second enterprise, and
the event detail represents the enterprise id of the second enterprise.

27. The method of claim 26 further comprising
locating a first event having an event type representing a transfer between enterprises and having an event detail representing the enterprise id for the second enterprise;
determining from the first event the enterprise id for the first enterprise; and
accessing at least a portion of the attribute data for the agricultural item in the first enterprise by selecting a second event having an enterprise id which represents the first enterprise.

28. The method of claim 13 wherein at least one agricultural item processing event comprises measuring an attribute datum related to the agricultural item, and gathering attribute data for the processing event comprises
determining the unit of production identifier associated with the processing event, and
storing, in a row of a first transactional event database,
the unit of production identifier,
an event type representing the type of measurement, and
an event detail representing the attribute datum.

29. A method for building a private data network for collecting and sharing agricultural item attribute data across multiple enterprises and across multiple forms of production, the method comprising:
providing at least one transactional event data base, the transactional event database having a plurality of rows, each row comprising
an enterprise id,
a unit of production type,
a unit of production identifier,
an event type, and
an event detail;
providing a data communication interface between the transactional event database and a plurality of enterprise applications;
extracting data from the enterprise applications to the transactional event data base; and
representing the data from the enterprise applications as atomic event data in the transactional event database such that each row in the transactional event data base comprises a detail associated with a single event.

30. The method of claim 29 further comprising
constructing at least one data mart by using a portion of the data in the transactional event data base.

31. The method of claim 29 further comprising
assembling into the data mart
first event data associated with a first enterprise and a first unit of production, the first event data including a first data attribute, and
second event data associated with a second enterprise and a second unit of production, the second event data including a second data attribute, such that the data mart provides a linkage of data attribute information for the agricultural item across a change in enterprise and across a change in unit of production.
